(19) United States
(12) Patent Application Publication
(10) Pub. No.: US 2007/0079315 A1
(43) Pub. Date: Apr. 5, 2007

(54) Hybrid turntable

(76) Inventor: Gregor Mittersinker, Warwick, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/244,128

(22) Filed: Oct. 5, 2005

(51) Int. Cl. G11B 17/04; G11B 17/03

(52) U.S. Cl. 720/656

(57) ABSTRACT

The hybrid turntable is capable of playing both digital media and vinyl record discs. A turntable includes a motorized platter and an independently rotating spindle. The rotation of the platter and spindle is independently rotatable. A interface control disc is connectable to the spindle to controllable rotate it. An adapter may be used to facilitate connection of the interface control disc to the spindle. The rotational position of the platter and the spindle is used for processing digital media to provide a digital audio output signal to generate a digitally simulated scratch type musical performance. Alternatively, a vinyl record disc can be positioned on the platter and about the spindle without connecting directly to the spindle. A tone arm is also be provided to communicate with the vinyl record disc to provide an analog phono audio output signal. An analog actual scratch type performance or normal phonographic playback is possible using the tone arm and vinyl record disc. A digital audio output signal and analog phono audio output can be selectively played back using the same turntable.

### BACKGROUND OF THE INVENTION

The invention relates generally to the playback and manipulation of audio. The present invention particularly relates to audio players that can manipulate audio in real time to provide different types of sound effects.

Turntables are well known in the prior art for use in the playback of audio, such as music, which are located on vinyl records. Details of the operation of an analog turntable is so well known, that details of the operation thereof need not be discussed herein. By way of background, these prior art turntables include a rotating platter that is driven by a motor either directly or via belts. A spindle is positioned at the axis of platter. A record, having a center hole, is positioned on the platter with the platter spindle routed through the hole. As a result, the vinyl record remains centered on the platter for rotation therewith.

A tone arm is provided with cartridge on the free end thereof. A needle in the cartridge communicates with grooves located on the vinyl surface of the record. It is well known that passage of the needle through the grooves of the vinyl record creates analog sound waves that are, in turn, electronically communicated through the tone arm for broadcast through a sound system. Typically, the record is played back in a forward direction and at its specified speed, such as 33⅓ rotations per minute. Such “normal” playback results in the recorded audio to played back as originally desired by the creator of the vinyl record.

However, it is possible that the playback of these prior art analog vinyl records can be manipulated to create unique sound effects. For example, the record can be sped up or slowed down or moved back and forth while the needle remains within the grooves of the vinyl record. This technique of manually altering the playback of vinyl records is known as the musical art form of “scratching” and can be done to any vinyl record, such as a recording of currently popular music.

In the industry of vinyl record scratching, special equipment has been designed over the years to accommodate this particular style of interactive playback of vinyl records. For example, specialized needles and turntables, with drive systems that are designed for constant back and forth movement of the platter, have been created. Also, slip mats are typically positioned between the vinyl record and the motor-driven platter to facilitate rotation of the record independently of the turntable platter. Different slip mats can be employed with differing levels of friction to suit the needs of the user of the scratch turntable. In view of the foregoing, the key to effective scratching is the physical interaction of the user with the record and the turntable and needle.

The use of the scratching technique of sound playback using vinyl records has become very popular. However, the sale and popularity of digital media, such as compact discs (CDs) and flash media have significantly increased over the years as the preferred medium for recording audio, such as music. Thus, digital audio has become preferred by many for its sound quality, ease of storage and playback. For example, digital audio is commonly stored as a digital file. It can be stored on any type of digital storage media, such as optical compact audio discs and magnetic discs, such as hard drives or compact flash media. As a result, turntables are not typically used to playback such digital music. Instead, digital compact disc players, computers and digital portable media players are now employed for playback.

While digital music has important advantages over analog vinyl records, there is a significant drawback in that digital audio cannot be scratched because digital audio is not played back on a record turntable like analog music. Thus, there has become a desire to simulate the scratching of digital audio to obtain similar results as scratching analog audio found on vinyl records.

There have been many attempts in the prior art to perform a scratch effect on a digital audio file. In the prior art, a digital audio file is typically loaded into a memory buffer from a compact disc or other storage medium. A rotating disc is typically employed with a sensor connected thereto to measure the speed and direction of the disc. Data concerning the rotation speed and direction of the disc is received by a digital microprocessor for digital signal processing according to a desired algorithm and system software. For example, if data is received by the microprocessor that the disc is being slowed down to half speed, then the microprocessor will cause the output signal to be slowed down accordingly to match the speed of the controller disc. Similarly, if the controller disc is rotated backwards, the microprocessor will process the digital audio and output it as reversed audio. Details of digital signal processing by a controller disc is well known in the art and need not be discussed in further detail herein.

In general, digital signal processing of digital audio to achieve scratching sound effects is quite realistic and suitable for performance by disc jockeys and the like. However, such scratch performers also require a physical interface that is as close as possible, both in look, feel and operation, to an analog turntable to provide as close as possible of a scratching performance. Most importantly, the physical interface for digital scratching will result in a scratch performance that most closely simulates an analog scratch performance.

The physical interface of prior art digital scratching devices do not closely simulate an analog turntable which disc jockeys and other performers are accustomed to. The interface controller discs of the prior art are typically small circular platters that are merely provided to only generally simulate an actual vinyl record found in a real analog turntable. As a result, the general feel and action of these prior art digital scratching devices are not particularly close to a real analog turntable.

However, there have been attempts in the prior to close simulate an analog scratch turntable with a digital device. For example, efforts have been made in the prior art to provide a separate “record” and platter which both have their own detectors connected thereto for monitoring of speed and directional. The “record” in these prior art devices is a custom vinyl or plastic disc that is connected to the spindle of the device. For example, these “records” have a special keyed center hole that engages with a specially configured turntable spindle. Also, the size of the disc is typically smaller than a normal LP disc. This custom disc must be used with the digital scratch turntables of the prior art.

Despite the high quality and ease of use of the digitally stored audio, vinyl records are still often used because disc jockeys commonly have a large archive of such vinyl records which they may not have replaced yet with digital versions thereof. Also, some disc jockeys may still prefer to scratch analog vinyl records to obtain a true, authentic scratch effect. Therefore, there still a need for disc jockeys to be able to playback and scratch vinyl records in analog fashion using a tone arm and cartridge. Thus, if a disc jockey wishes to playback and scratch both digitally stored media as well as vinyl records, they must own both a digital playback and scratch device as well as an analog vinyl turntable. This is not only costly but burdensome for the disc jockey in that they must travel with two turntables to a performance.

In view of the foregoing, there is a demand for a hybrid turntable that can playback and scratch vinyl records as well as closely simulate analog scratching of vinyl records, using digitally stored audio, not only from a sound output standpoint but also from a physical interface standpoint. There is a particular demand for a hybrid turntable that can function either as a digital scratch turntable that is virtually indistinguishable from an analog turntable or an analog vinyl turntable. There is a demand for the interface “record” to be as close as possible to a real vinyl record. There is a demand for such a digital scratch turntable to include a platter that is identical to platters found in analog turntables. There is a further demand for a digital scratch turntable to use a slip mat to more closely simulate analog scratch action. Also, there is a demand for a digital scratch turntable to have the feel of an analog turntable to improve the overall scratch performance and enjoyment of the performer. There is a demand for a hybrid turntable where the platter is used both to carry a control interface disc for digital scratching of digitally stored audio and for supporting an vinyl record disc during communication with a tone arm and cartridge for analog audio playback.

### SUMMARY OF THE INVENTION

The present invention preserves the advantages of prior art digital and analog scratch turntables. In addition, it provides new advantages not found in currently available turntables and overcomes many disadvantages of such currently available turntables.

The invention is generally directed to the novel and unique hybrid turntable that can play both digital media and analog vinyl records. The turntable of the present invention has particular use in the disc jockey music industry in that the hybrid turntable can be used to simulate a scratch performance using digital audio while also being able to scratch an analog vinyl record while using the same turntable. The digital audio and analog audio can be selectively played back.

The hybrid turntable is capable of playing both digital media and vinyl record discs with the same turntable. The turntable includes a motorized platter and an independently rotating spindle. The rotation of the platter and spindle is independently rotatable. A interface control disc is connectable to the spindle to controllable rotate it. An adapter may be used to facilitate connection of the interface control disc to the spindle. The rotational position of the platter and the spindle is used for processing digital media to provide a digital audio output signal to generate a digitally simulated scratch type musical performance. Alternatively, a vinyl record disc can be positioned on the platter and about the spindle without connecting directly to the spindle. A tone arm is also be provided to communicate with the vinyl record disc to provide an analog phono audio output signal. An analog actual scratch type performance or normal phonographic playback is possible using the tone arm and vinyl record disc. A digital audio output signal and analog phono audio output can be selectively played back using the same turntable.

It is therefore an object of the present invention to provide a hybrid turntable that can playback digital media and analog vinyl records using the same turntable.

It is another object of the present invention to provide a hybrid turntable that can digitally scratch digital media and scratch analog vinyl records using the same turntable.

It is an object of the present invention to provide a hybrid turntable that that can be easily modified to play either digital media or analog vinyl records.

It is a further object of the present invention to provide a hybrid turntable that includes an adapter that facilitates that mounting of an interface control disc to the turntable for digital scratching.

Another object of the present invention is to provide a hybrid turntable that enables a disc jockey to play and scratch both digital and analog audio.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of the hybrid turntable of the present invention being in a digital playback mode of use;

FIG. 2 is a perspective view of the hybrid turntable of the present invention in an analog playback mode of use;

FIG. 3 is a close-up perspective view of an analog vinyl record disc installed on the spindle of the hybrid turntable of the present invention;

FIG. 4 is an exploded front view of the interface control member and platter construction in accordance with the present invention;

FIG. 5 is a top view of the spindle of the hybrid turntable of the present invention;

FIG. 6 is a plan view of the top plate of the adapter of the present invention;

FIG. 7 is a plan view of the bottom plate of the adapter of the present invention;

FIG. 8 is a cross-section line through the line 8-8 of FIG. 4;

FIG. 9 is a top perspective view of the hybrid turntable of the present invention with the interface control member, with adapter installed thereon, in the process of being installed on the platter and spindle for playback of audio from a digital media source;

FIG. 10 is a perspective view of the base and motor assembly of the hybrid turntable of the present invention;

FIG. 11 is a partially broken away side elevational view of the motor assembly of the hybrid turntable of the present invention;

FIG. 12 is a bottom perspective view of the platter of the hybrid turntable of the present invention; and

FIG. 13 is a flowchart of the processing of the digital audio stream in accordance with the present invention.

### DETAILED DESCRIPTION OF THE PREFERRED EMBODIMENT

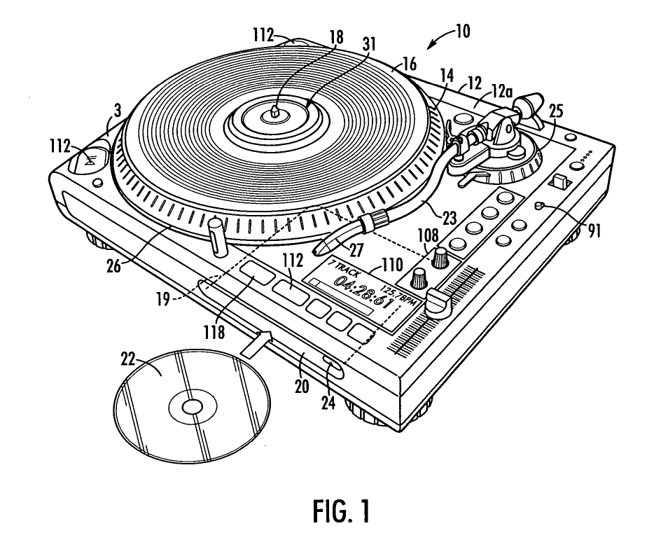

Referring first to FIG. 1, a perspective view of the hybrid turntable sound playback device 10 of the present invention is shown. The device 10 is audio playback machine that, in general, reads a digital audio file from storage and places it into memory for later custom, on-the-fly manipulation by the user to modify the playback thereof for added enjoyment of the audio itself as well as playback of analog vinyl records.

For digital audio playback, the audio file can be retrieved from any storage medium, such as compact disc (“CD”) or hard drive. For ease of discussion and illustration, the present invention is shown and described in detail in connection with retrieving a digital audio file from a CD, however, it should be understood that the present invention can be used to retrieve a digital audio file for later manipulation from any storage medium, such as a hard drive or removable media, such as flash memory cards. The scope of the present invention is intended to cover any type of the foregoing storage mediums.

The hybrid turntable playback device 10 is an electrical device that is driven by a power source, such as AC power, using a wall outlet, and the like. As will be described below, various electronic components are employed in the device of the present invention. The nature and type of the power supply can be modified to suit the components employed in the playback device.

Still referring to FIG. 1, the hybrid turntable playback device 10 of the present invention is first shown in a digital playback and scratch mode which includes an outer main housing 12 with a turntable platter 14 rotatably mounted thereon. A user control disc 16, preferably an actual vinyl record, is removably connected to a center spindle 18 using a unique adapter, generally referred to as 31, which will be described in detail below. For example, a user's favorite vinyl record can be used as the circular disc 16. As will be described in detail below, the speed and direction of platter 14 and the circular disc 16 are independently monitored so that control signals are generate to modification of an audio signal.

The playback device 10 also includes a number of user controls positioned about the top surface 12a of the main housing 12 of device 10. The nature and layout of the user controls is preferably provided to best suit the needs of a disc jockey. Since the hybrid turntable 10 of the present invention is used both for digital playback and analog playback of vinyl records, the user controls are provided that provide a playback device that simulates an analog scratch turntable as closely as possible which are very familiar to disc jockeys. As can be seen, the appearance of the hybrid turntable playback device 10 closely resembles a standard analog scratch.

The playback device 10 of the present invention includes a build-in optical reader 19, namely, otherwise known as a compact disc drive. A front loading slot 20 is located in the front of the device for receiving a compact disc 22. Drawer-based loading of the compact disc 22 may be used instead of the slot loading shown in FIG. 1. The compact disc player 19 optically reads the digital audio data on the optical disc 22 and outputs digital audio waveform data. Compact disc players 19 are well known in the art and need not be discussed in further detail herein. An eject button 24 is employed for ejecting the compact disc 22 when further use of that disc is no longer needed. Various buttons are provided for complete control of the playback of the selected audio signal. Further details of the user controls Will be discussed below in connection with the operation and use of the playback device of the present invention.

The hybrid turntable playback device 10 of the present invention also includes a tone arm 23 which is pivotally mounted to a base 25. A cartridge 27 is also connected to the tone arm 23 to carry analog audio signals through the tone arm 23 and the base 25 to the electronics within the main body 12 of the hybrid turntable playback device 10. The cartridge, tone arm 23 and base 25 construction operate in a fashion that is well known in the art and need not be discussed in further detail herein.

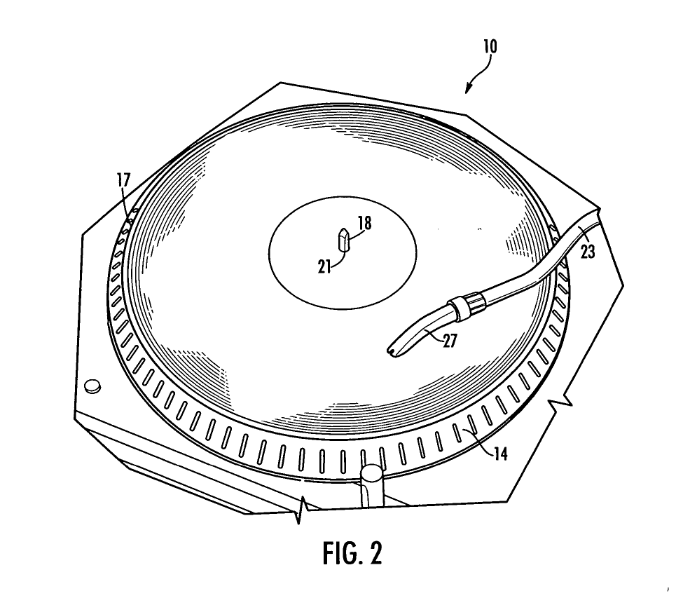

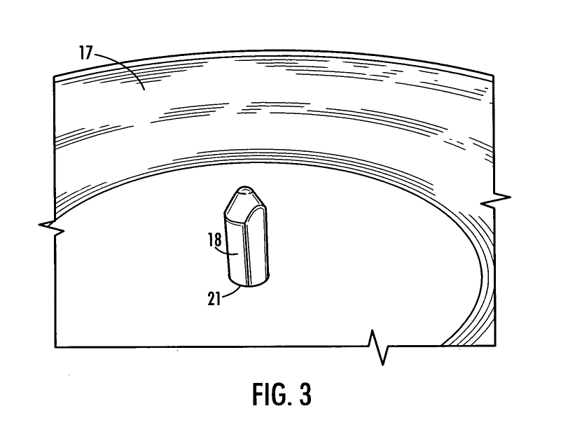

For analog playback using the tone arm 23 and cartridge 27, as best seen m FIGS. 2 and 3, the user control disc 16, with adapter 31 installed thereon, is removed and replaced with a vinyl record 17. As seen in FIG. 3, the vinyl record 17 includes a central hole 21 into which the spindle 18 is received. The tone arm 23 and cartridge 27 are rotated about the base 25 so that the cartridge engages the surface of the vinyl record 17 for playback in the normal analog fashion. Thus, the same platter 14 is used to receive and support both the user control disc 16 and adapter 31 when in a digital scratching mode, as in FIG. 1, and a vinyl disc 17 when in an analog scratching mode, as in FIG. 2.

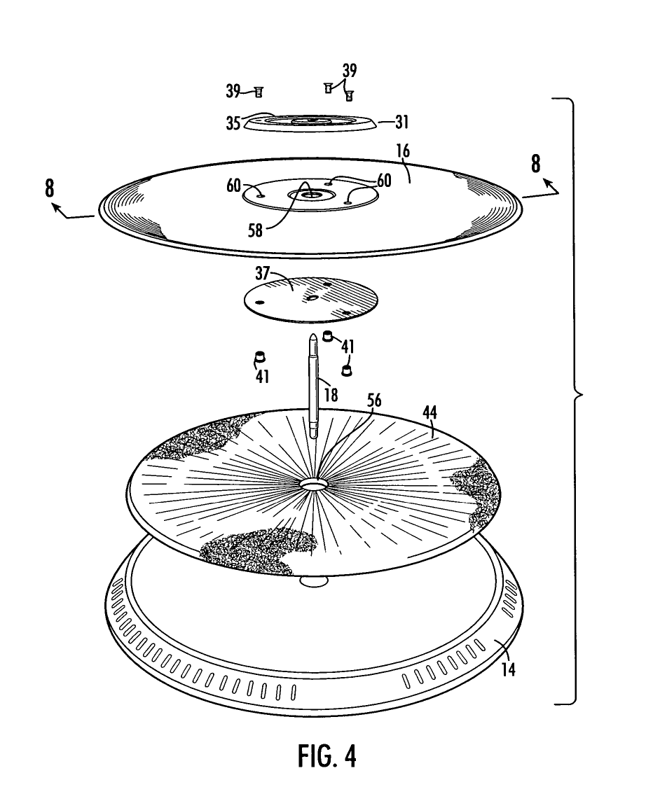

Turning now to FIG. 4, an exploded perspective view of the user control disc 16 with adapter 31 installed thereon and slip mat 44 over the platter 14. A standard slip mat 44 is placed over the top surface 14a of the platter 14. Scratch slip mats 44 are commonly made of foam or felt and provide the needed combination of slippage and grip of a record relative to the platter that is essential to proper scratching feel. The slip mat 44 includes a center hole 56 that permits the center spindle 18 to emanate upwardly therethrough.

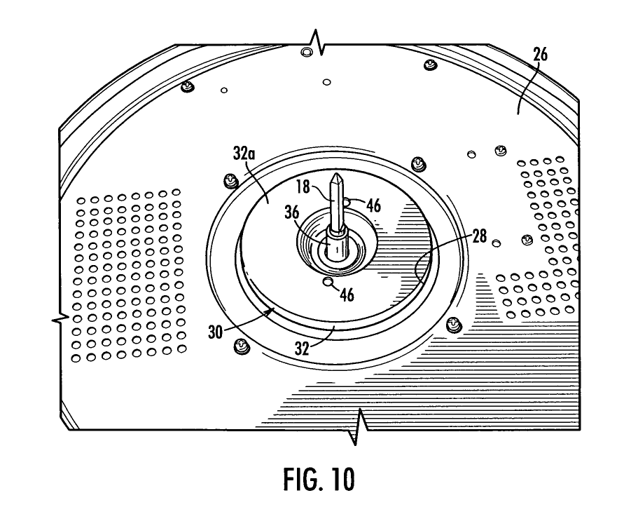

The user control disc 16, as stated above, is typically a standard vinyl disc with a round center hole 58. As can be understood, for digital scratching, the platter 14 and the spindle 18 must independently rotate relative to one another so their rotation can be separately detected for simulated digital scratching and playback. Details of the construction of the motor assembly and digital encoders are discussed in connection with FIGS. 10-12 below. For the digital scratching to function accurately and realistically, the user control disc 16 must be directly connected to the spindle 18 so that movement of the user control disc 16 is translated to the spindle which is being digitally encoded for simulated digital scratching. Also, in this hybrid turntable playback device, the spindle 18 must be able to accommodate both a user control disc 16 for digital playback as well as a vinyl record for analog playback.

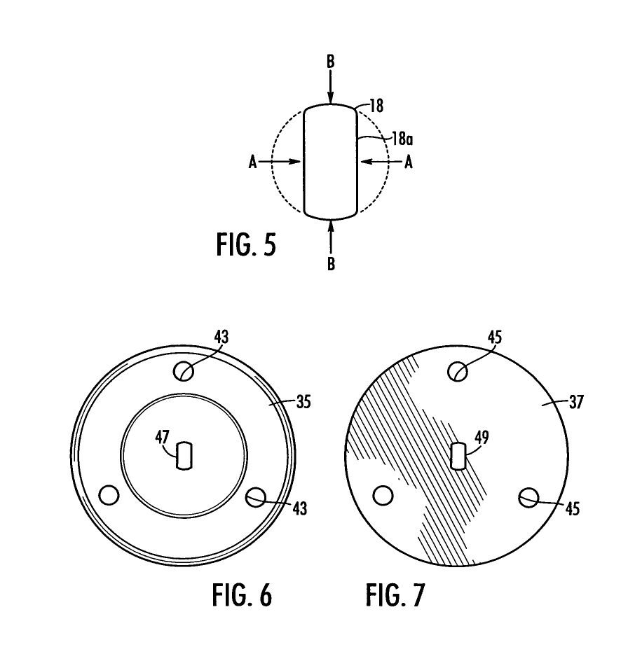

To accomplish this, as seen in FIG. 5, the spindle 18 is uniquely configured to have a non-circular cross-section for the purpose of rotationally keying a user control disc 16 which is removably connected thereto. In the preferred embodiment of FIG. 5, the spindle 18 has an oblong shape with a first width dimension B that is approximately the same as the diameter of a typical vinyl record, which is about 7.3 MM. The spindle 18 has a second transverse width dimension A that is less than the dimension B. Thus, this non-circular shape of the spindle 18 acts as a rotational key so that when the user control disc 16, with adapter 31 installed thereon, is placed over the spindle 18, rotation of the user control disc 16 will effectively rotate the spindle 18. While an oblong spindle 18 with flat opposing sides 18a is preferred, other non-circular keying configurations can be employed and still be within the scope of the present invention. For example a triangular shaped spindle 18 can also provide the needed keying action with a complementary shaped triangular hole defined by the adapter 31.

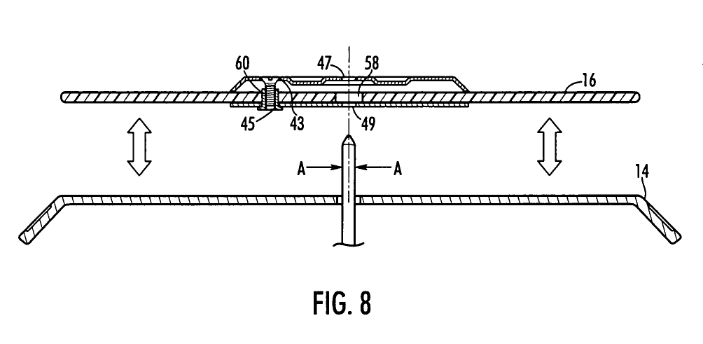

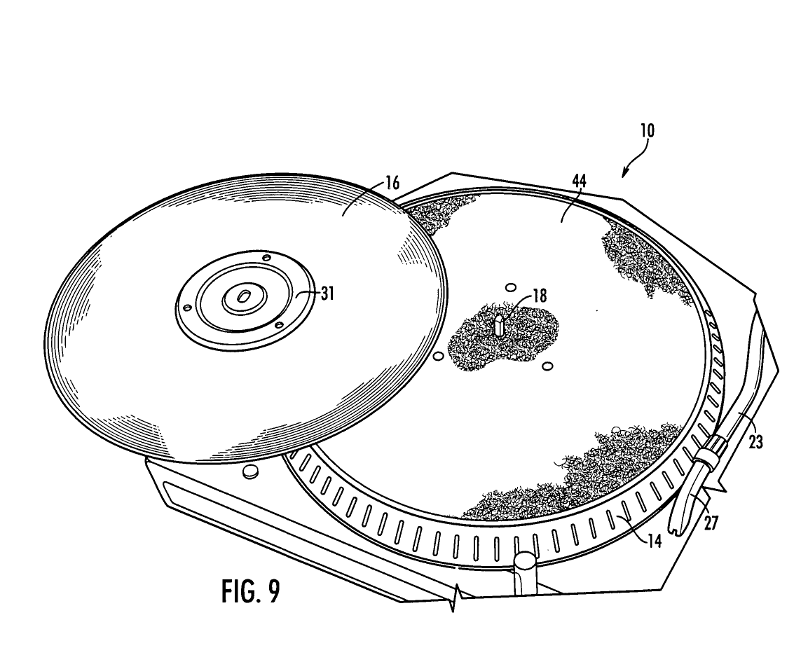

If a standard vinyl record, with a circular hole therethrough, is desired to be used as a user control disc 16, then its circular hole must be adapted to complementarily key with the non-circular spindle 18. The adapter 31 effectively adapts a standard vinyl record disc to one a user control disc that can effectively rotate spindle 18. Referring to FIG. 4., a number of holes 60, preferably three in number, are provided through the control disc 16. Preferably, the vinyl disc, acting as a user control disc 16, is sandwiched between top plate 35 and bottom plate 37. Plan views of the top plate 35 and bottom plate 37 are show in FIGS. 6 and 7, respectively. The top plate 35, with holes 43 therethrough, is preferably connected to the bottom plate 37, with holes 45 therethrough, by the engagement of screws 39 with threaded standoffs 41, which can be seen in detail in FIG. 8, which is a cross-sectional view through the line 8-8 of FIG. 4. The top plate 35 includes a center keying aperture 47 which is substantially complementary to the spindle. The bottom plate 37 includes a center keying aperture 49 which is substantially complementary to the spindle.

In the cross-sectional view of FIG. 8, only one hole 60, through the disc 16, one hole 43, through the top plate 35, and one hole 45, through the bottom plate 37, and the center aperture 58 can be seen because the other two holes 60 are not in the same cross-sectional plane. The top plate 35 and bottom plate 37 sandwich the user disc 16 with their respective center apertures 47 and 49 aligned to receive the spindle 18 therethrough. In order for the disc 16, with adapter 31 thereon, to be able to be placed over spindle 18, the disc 16 must be rotated so that the oblong apertures 47 and 49 of the top plate 35 and bottom plate 37, respectively, are rotationally aligned with the spindle 18, whereby the reduced width A of the spindle 18 is aligned therewith. With this proper alignment, the disc 16 can be easily installed and removed from the spindle 18 while being able to effectively rotate the spindle for a simulated scratching as described above.

Turning now to FIG. 9, a perspective view of the turntable 10 shows a user disc 16, with adapter 31 installed thereon, in the process of being installed over the keying spindle 18 for communication with the platter 14 with slip mat 44 disposed therebetween. In this mode of use, the tone arm construction (23, 25, 27) is not in use.

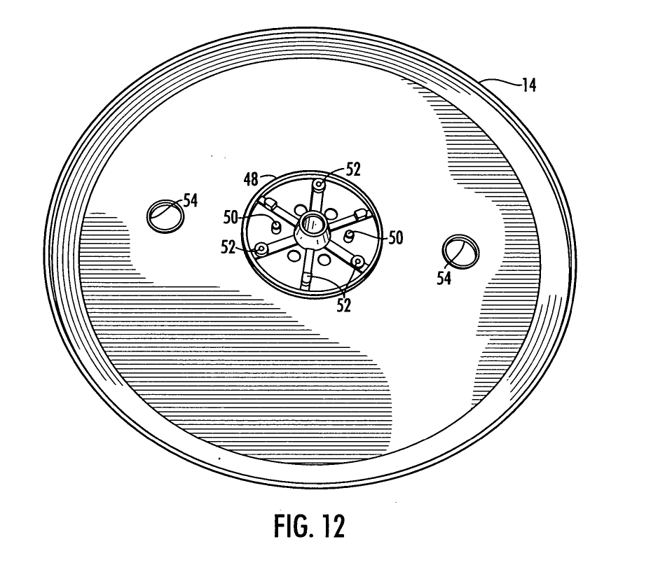

Referring now to FIGS. 10-12, details of the construction of the turntable motor and digital encoders are shown in detail. A pass-through aperture 28 in the base plate 26 of the turntable housing 3, as seen in FIG. 1, for receiving the motor body 32 of a direct drive motor 30 therethrough. The motor 30 includes a motor housing 32 with a annular-shaped magnet 34 affixed to the inner surface thereof. A hollow spindle 36 is affixed to the outer housing 32 of the motor 30. As a result, the motor housing 32 rotates in unison with hollow spindle 36. As shown in FIG. 12, a plurality of wire coils 38, mounted on posts 40, emanate radially outward toward the annular magnet 34 within the motor 30. The coils 38 are preferably wound from of metal wire, such as copper, as is well known in the art. The posts 40 that support the coils 38 are mounted to a support circuit board 42 which is, in turn, mounted to the base plate 26 which is attached to the main housing 12 of the turntable playback device 10. When electricity is passed through the coils 38, the annular magnet 34 and motor housing 32 rotate in unison thereby providing a direct motorized drive for the platter 14. The hollow spindle 36 is preferably made of metal, such as aluminum, or can be other materials, such as plastic.

The center 18 spindle is co-axially mounted through the hollow spindle 36 and freely rotates within the hollow spindle 36. The center spindle 18 is preferably made of metal, such as aluminum, or can be other materials, such as plastic. The activation of the coils 38 only rotates the annular magnet 34 (e.g. metallic) and motor housing 32 connected thereto not the center spindle 18.

The motor 30 is preferably high-torque with a power of 4.5 kgf-cm. The motor 30 can operate at 33 RPM or 45 RPM. A direct drive motor 30 is preferred over other types of motors for its reliability and performance. Also, stationary coils 38 are preferred, however, other types of motors, such as ones with a stationary magnet, are also contemplated by the present invention. These motor configurations are considered to be within the scope of the present invention.

Details of the interconnection of the turntable platter 14 to the motor housing 32 is seen in FIGS. 10 and 12. In FIG. 10, a perspective view is shown of the motor 30 extending upwardly through the aperture 28 in base plate 26. As described above, the motor housing 32 rotates within the aperture 28 in the base plate 26 when electricity is passed through the coils 38 in the motor 30. A number of keying holes 46 are provided on the top 32a surface of the motor housing 32 for engaging with the turntable platter 14, the bottom of which is shown in FIG. 12. The bottom of the platter 14, which is preferably made of aluminum, includes a mounting connection area in the center thereof, generally referred to as 48. The mounting connection area 48 includes a pair of keying posts 50 that engage with and reside in the keying holes 46 on the top surface 32a of the motor housing 32. A number of contact pads 52 are also provide within the mounting connection area 48 to communicate with the flat top surface 32a of the motor housing 32 to ensure that the platter 14 remains level and parallel with the top surface 32a of the motor housing 32. The platter 14 simply rests on the top of the motor housing 32 and is held in place by gravity. Finger holes 54 are also provided to facilitate handling of the platter 14.

As a result of the keying engagement of the platter 14 to the motor housing 32, electrical activation of the coils 38 in the motor 30 will effectively rotate the motor housing 32 and the platter 14 simultaneously. Thus, the platter 14 can be rotated to, in turn rotate a vinyl disc 17 resting thereon and play it using the tone arm construction 23, 25 27 in analog playback mode. For digital scratching, the center spindle 18 through the center of the platter 14 rotates independently of the platter 14. When the turntable 10 is used in an analog playback mode, the independent rotation of the spindle 18 is of no consequence because it does not affect the use of the turntable 10 in analog playback mode because the digital encoders are preferably not used.

In accordance with the present invention, the platter 14 and circular disc 16 rotate independently from one another. The platter 14 is connected to the motor 30 which controls the rotation thereof. In the digital scratching mode of use, the rotation of the center spindle 18 is controlled by the user's on-the-fly manipulation in real time. The interface for accomplishing this is a standard sized vinyl record, generally referred to as a circular disc 16, as mentioned above.

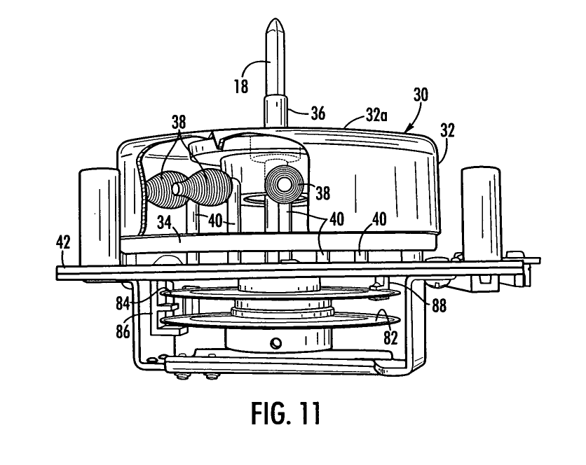

Referring back to FIG. 11, details of the rotation speed and direction detection of the disc 16 and platter 14 are shown for when the turntable 10 is used in a digital scratching mode. A first encoding disc 82 is provided for the center spindle 18 and circular disc 16 connected thereto and a second encoding disc 84 is provided for the hollow spindle 36 and the platter 14 connected thereto. Optical detectors 86, 88 are respectively provided for each of the encoding discs 82, 84.

Use of digital encoding discs using optical sensors for the determination of speed and direction of rotation are well known in the art and need not be discussed in further detail herein. The encoder discs 82, 84 are preferably made of stamped or perforated metal, such as steel or aluminum but could be made of other materials. In that connection, there are many different methods for measuring the speed and direction of rotation of the hollow spindle 36 and center spindle 18. However, it should be understood that many other techniques for detecting the rotation speed and direction of the spindles 18, 36 are contemplated herein and are within the scope of the present invention.

For operation of the present invention, the turntable playback device 10 is powered up and mode switch 91 is appropriately set to indicate whether the turntable is to operate in a digital mode or analog playback mode. For digital mode, a compact disc 22 is inserted into the slot 20 in the front of the device 10 and is effectively loaded into the compact disc optical reader 19. An audio track is selected using the selector knobs 108 and display 110 for playback from the optical disc 22. Alternatively, as discussed above, the playback device 10 of the present invention may include a hard drive or memory disc from which the audio file may be retrieved. Once the audio file is loaded from the appropriate storage source, two PLAY buttons 112 are provided. Either button 112 can be depressed to start playback of the audio track. At this point, the platter 14 will simultaneously begin to rotate to simulate playback as if it were on a true analog turntable. Thus, the rotation of the platter 14 indicates that playback is in progress. In this condition, the platter 14 is being driven by the motor 30. In this digital mode, the tone arm construction 23, 25, 27 is not used.

During this normal speed playback, the circular disc 16 is in frictional communication with the platter 14 via the slip mat 44. There is enough friction therebetween that the circular disc 16 rotates in synchronization with the platter 14. The speeds and direction of both the circular disc 16 (i.e. vinyl record with adapter 31 installed thereon) and the platter 14 will be detected by their respective optical encoders 82, 84 and sensors 96, 98 as being equal. Thus, the microprocessor 100 simply plays back the audio signal without modification as outputted by the optical reader 19. The playback signal is based on speed and direction of both the circular 16 disk and platter 14.

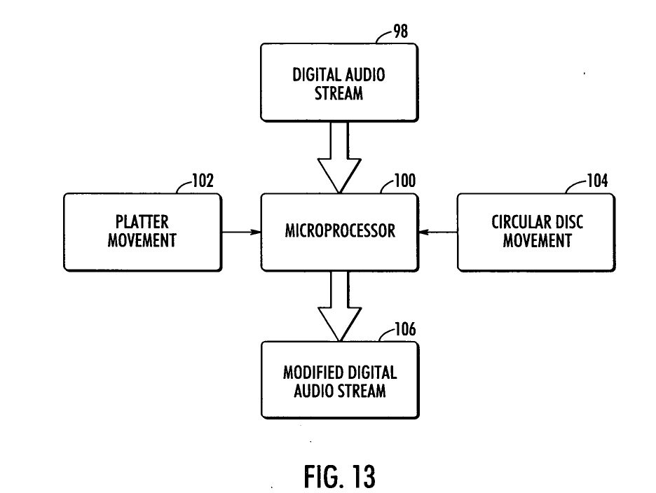

As illustrated in FIG. 13, for playback of a modified audio signal, such as scratch playing, the speed and/or direction of one or both of the platter 14 and the circular disc 16 are altered by the user of the playback device 10. For example, both the platter 14 and the circular disc 16 can be slowed down the same amount. The microprocessor 100 uses the information to output the appropriate slowed down audio. In another example, if the platter 14 is moving forward at normal speed and the circular disc 16 is moving reverse at normal speed, then the outputted audio 106 will be the audio signal played in reverse. For scratching, it is possible that the platter 14 is moving forward while the circular disc 16 is being moved back and forth. Scratching, pitch bending and cueing can be easily carried out with the present invention.

Thus, the optical detectors 82, 84 will sense all of the relative movements of the circular disc 16 and the platter 14 to deliver real time signals to the microprocessor 100 to play the audio signal forward and backward according to the actions sensed. This processing can be carried out by software that is in read only memory (ROM), onboard a chip or loaded via removable storage.

It should be noted that real time microprocessor control of a audio signal based on the input of some type of user controller is well known in the art. Therefore, further details thereof need not be addressed herein.

The playback device 10 of the present invention includes many operational features to take advantage of the realistic record control of an audio signal. Referring back to FIG. 1, the power switch (not shown) is engaged to deliver power to the device 10. A compact disc 22, that contains the audio file to be manipulated, is inserted into CD ROM drive 19 via the front-loading slot. The eject button 24 ejects the compact disc 22 from the CD ROM drive 19. The TRACK/MENU SELECT knob 108 is rotated to select tracks. Depressing it selects is for playback. The PLAY/PAUSE 112 buttons starts and stops playback and the platter 14. Pressing buttons 112 toggles between PLAY and PAUSE of the platter. Each time a PLAY button 112 is pressed after PAUSE, a new cue point is set. A CUE button 118 returns and pauses the audio at the last set cue point. Various other operations can be carried out by the device to control digital transport.

For use as an analog turntable, the turntable 10 is switched into analog mode by setting switch 91 in FIG. 1 to analog. Now, the turntable will operate like a standard analog turntable. As discussed in connection with FIG. 2, the tone arm is rotated into place over the vinyl disc 17 so the cartridge 27 can communicate with the desired portion thereof. If desired, analog scratching of disc 17 can also be accomplished with a slip mat 44 preferably being used.

Therefore, the turntable 10 of the present invention can be operate in either a digital playback mode or an analog playback mode where playback can be “scratched” in either mode, if desired. It is also possible, to create unique sound effects, to use the turntable 10 in the digital and analog playback modes simultaneously.

The playback device 10 of the present invention can be easily connected to other audio and video equipment by an audio/video set of connectors, on the back of the device (not shown). Such electrical interconnections to the audio sub-system of the turntable 10 are very well known in the art and need not be further discussed. In general, RCA-type connectors for left and right channel are preferably provided as well as a digital output. A relay connector and a remote start connector can also be provided. Input and output ports for Music Instrument Digital Interface (MIDI) can also be provided for digital interconnection to other MIDI devices. A voltage selector and power plug connector can also be provided. Such connectors are well known in the art and are familiar to disc jockeys and audio technicians.

It would be appreciated by those skilled in the art that various changes and modifications can be made to the illustrated embodiments without departing from the spirit of the present invention. All such modifications and changes are intended to be covered by the appended claims.

What is claimed is:

1. A sound playback device controllable by a user, comprising:
a motor;
a hollow spindle, having a rotational axis, connected to and driven by the motor;
a platter connected to the hollow spindle; the platter having a rotational speed and direction;
a center spindle, having a rotational axis and a top free end, routed through the hollow spindle; the rotational axis of the hollow spindle being co-axial with the rotational axis of the center spindle; the center spindle having a rotational speed and direction and a non-circular cross-sectional shape;
a user manipulateable member having a central circular hole therethrough with a rotational speed and direction and a top side and a bottom side; the bottom side facing the platter;
adapter means attached to the user manipulateable member for reducing the size of the central circular hole therethrough to a shape that is substantially keyingly matable to the non-circular cross-sectional shape of the center spindle;
means for detecting the rotational speed and direction of the platter to create a platter control signal;
means for detecting the rotational speed and direction of the user manipulateable member to create a user manipulateable member control signal;
a digitized audio signal;
processing means for modifying the digitized audio depending on the platter control signal and the user manipulateable member control signal to create an digital audio output signal;
whereby the user manipulatable member with adapter means thereon can be remove from the spindle to permit loading of a standard vinyl record thereon.

2. The sound playback device of claim 1, further comprising:
a tone arm positioned proximal to the platter and being capable of communication with a standard vinyl record, when located on the platter, to generate a phono output signal therefrom.

3. The sound playback device of claim 1, wherein the adapter means is a top plate attached to the top side of the user manipulateable member that defines an aperture therethrough having a shape that is substantially matable with the non-cross-sectional shape of the center spindle; the aperture of the top plate being substantially aligned with the center hole of the user manipulateable member.

4. The sound playback device of claim 1, wherein the adapter means is a bottom plate attached to the bottom side of the user manipulateable member that defines an aperture therethrough having a shape that is substantially matable with the non-cross-sectional shape of the center spindle; the aperture of the bottom plate being substantially aligned with the center hole of the user manipulateable member.

5. The sound playback device of claim 1, wherein the adapter means is a top plate attached to the top side of the user manipulateable member that defines an aperture therethrough having a shape that is substantially matable with the non-cross-sectional shape of the center spindle; the aperture of the top plate being substantially aligned with the center hole of the user manipulateable member and a bottom plate attached to the bottom side of the user manipulateable member that defines an aperture therethrough having a shape that is substantially matable with the non-cross-sectional shape of the center spindle; the aperture of the bottom plate being substantially aligned with the center hole of the user manipulateable member.

6. The sound playback device of claim 5, further comprising means for connecting the top plate to the bottom plate.

7. The sound playback device of claim 6, wherein the means for connecting are at least one threaded fastener, in communication with the top plate, threadably connected to a threaded standoff which is in communication with the bottom plate.

8. The device of claim 1, wherein the motor is a direct drive motor.

9. The device of claim 1, wherein the hollow spindle and the center spindle are routed through the direct drive motor.

10. The device of claim 1, wherein the user manipulateable member is a circular disc.

11. The device of claim 10, wherein the circular disc is a vinyl record.

12. The device of claim 10, wherein the circular disc and adapter means is removably connected to the center spindle.

13. The device of claim 1, wherein the user manipulateable member is in frictional communication with the platter.

14. The device of claim 1, further comprising a slip mat disposed between the user manipulateable member and the platter.

15. The device of claim 1, wherein means for detecting the rotational speed and direction of the platter to create a platter control signal further comprises:
a first digitally encoded disc connected to the hollow spindle; and
a first optical sensor positioned proximal to the first digitally encoded disc.

16. The device of claim 1, wherein means for detecting the rotational speed and direction of the user manipulateable member to create a user manipulateable member control signal further comprises:
a second digitally encoded disc connected to the center spindle; and
a second optical sensor positioned proximal to the second digitally encoded disc.

17. The device of claim 1, wherein the sound playback device can selectively play the digital audio output signal and the phono output signal.

18. An adapter for a vinyl disc, having a top side, bottom side and a center hole, for use with a digital turntable with a platter and a center spindle, having a non-circular cross-sectional shape, that move independently of one another, comprising:
a top plate attached to the top side of the vinyl disc and defining an aperture therethrough having a shape that is substantially matable with the non-cross-sectional shape of the center spindle; the aperture of the top plate being substantially aligned with the center hole of the vinyl disc.

19. The adapter of claim 18, further comprising:
a bottom plate attached to the bottom side of the vinyl disc and defining an aperture therethrough having a shape that is substantially matable with the non-cross-sectional shape of the center spindle; the aperture of the bottom plate being substantially aligned with the center hole of the vinyl disc.

20. The adapter of claim 18, wherein the top plate and the bottom plate are connected to each other.

21. A hybrid turntable that is capable of playing digital media and vinyl record discs, comprising:
a main body;
a motorized platter, having an aperture therethrough, rotatably mounted to the main body; means for detecting rotation of the platter;
a spindle routed through the aperture in the platter; interface means connected to the spindle for controlling rotation of the spindle; means for detecting rotation of the spindle; the motorized platter and the spindle being independently rotatable relative to each other; rotational position of the platter and the spindle being used for processing digital media to provide a digital audio output signal;
a vinyl disc, having a center hole, positionable on the platter with the spindle routed through the center hole of the vinyl disc;
a tone arm connected to the main body and being capable of playing back a vinyl record positioned on the motorized platter to provide a phono output signal;
whereby the interface means and the vinyl disc are interchangeably connected to the spindle and positioned on the platter, respectively.

22. The hybrid turntable of claim 21, wherein the interface means is a vinyl disc.

23. The hybrid turntable of claim 21, wherein the interface means is a plastic disc.

24. The hybrid turntable of claim 21, further comprising:
a slip mat positioned between the interface means and the platter.

25. The hybrid turntable of claim 21, further comprising:
a slip mat positioned between the vinyl disc and the platter.

26. The hybrid turntable of claim 21, wherein the digital audio output signal and the phono output signal are alternatively played.

27. The hybrid turntable of claim 21, wherein the digital audio output signal and the phono output signal are simultaneously played.
